(19) United States
(12) Patent Application Publication
(10) Pub. No.: US 2022/0236068 A1
(43) Pub. Date: Jul. 28, 2022

(54) AR NAVIGATION SYSTEM AND AR NAVIGATION

(71) Applicant: Sichuan Smart Kids Technology Co., Ltd., Sichuan (CN)

(72) Inventor: Weiqi ZHAO, Sichuan (CN)

(21) Appl. No.: 17/581,011

(22) Filed: Jan. 21, 2022

(30) Foreign Application Priority Data
Jan. 22, 2021 (CN) 202110089295.4

(51) Int. Cl. G01C 21/36; G06F 3/01; G02B 27/00; G02B 27/01

(52) U.S. Cl. CPC G01C 21/3638; G01C 21/365; G01C 21/362; G01C 21/367; G02B 2027/0187; G06F 3/012; G02B 27/0093; G02B 27/0179; G02B 27/0172; G01C 21/3697

(57) ABSTRACT

An augmented reality (AR) navigation system: includes an AR display device configured to provide a near-eye display function; and a mobile terminal communicatively connected with the AR display device, where the mobile terminal is configured to send a control instruction to the AR display device, so that the AR display device displays AR content corresponding to the control instruction. Through one or more embodiments disclosed in the present invention, display content of the AR display device may be controlled by the mobile terminal, so that there is no need to identify a target through a complex algorithm such as CV. The technical implementation cost is low and the user experience is high, which can meet the requirements of some specific navigation scenes.

### TECHNICAL FIELD

The present invention relates to the field of software systems, and in particular, to a system and method for AR navigation through an AR display device.

### BACKGROUND

At present, a conventional navigation method is to introduce content of related scenes (such as museums, or exhibition halls) to users through voice explanation equipment, and is lack of effective interaction with users. Navigation systems and methods based on AR devices are also gradually popularized. However, the existing navigation based on AR devices is to identify a target object using a CV algorithm and then plays some AR content to the user.

In some scenes, due to environmental constraints, the AR device may not be able to identify a target object, resulting in that the AR content cannot be presented in time, thus resulting in a poor user experience. Moreover, the identification of the CV algorithm requires the target object to be trained in advance, and the cost of the navigation solution is relatively high.

### SUMMARY

An objective of the present invention is to provide a new AR navigation system and an AR navigation method, which can control the AR display device to display AR content through a mobile terminal, so as to meet the navigation requirements of some specific scenes.

According to one aspect of the present invention, one or more implementations of the present invention disclose an AR navigation system, including: an AR display device configured to provide a near-eye display function; and a mobile terminal communicatively connected with the AR display device, where the mobile terminal is configured to send a control instruction to the AR display device, so that the AR display device displays AR content corresponding to the control instruction.

According to another aspect of the present invention, one or more implementations of the present invention disclose an AR navigation method, including: an AR display device being configured to be communicatively connected with a mobile terminal and receive a control instruction from the mobile terminal; and displaying, by the AR display device according to the control instruction, AR content corresponding to the control instruction.

Through one or more embodiments disclosed in the present invention, display content of the AR display device may be controlled by the mobile terminal, so that there is no need to identify a target object through a complex algorithm such as a CV algorithm. The technical implementation cost is low, the user experience is high, which can meet the requirements of some specific navigation scenes.

### BRIEF DESCRIPTION OF THE DRAWINGS

FIG. 1 illustrates a schematic diagram of an AR navigation system according to one or more embodiments of the present invention;

FIG. 2 illustrates a schematic diagram of a UI interface of a mobile terminal of an AR navigation system according to one or more embodiments of the present invention;

FIG. 3 illustrates a schematic diagram of a UI interface of a mobile terminal of an AR navigation system according to one or more embodiments of the present invention; and

FIG. 4 illustrates a flowchart of an AR navigation method according to one or more embodiments of the present invention.

### DETAILED DESCRIPTION

To further explain the technical means and effects of the present invention to achieve the intended creative objective, the specific implementation, structure, features and effects of the AR navigation system and the AR navigation method proposed according to the present invention will be described in detail below in combination with the accompanying drawings and preferred embodiments.

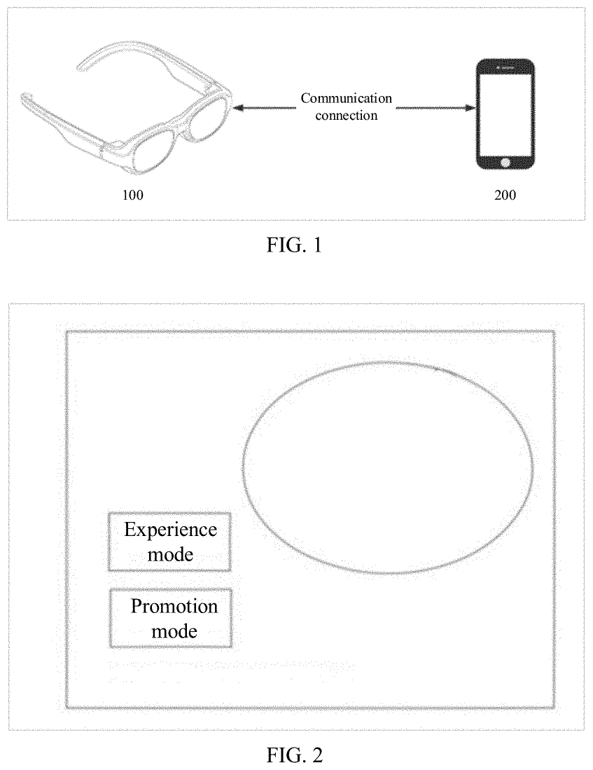

According to one aspect of the present invention, as shown in FIG. 1, a schematic diagram of an AR navigation system according to one or more embodiments of the present invention is shown, including an AR display device 100 and a mobile terminal 200, the AR display device 100 being communicatively connected with the mobile terminal 200. In particular, the AR display device 100 may superimpose virtual information to the real world, so that a wearer may see the virtual information while seeing a real world picture, so that the two types of information may complement each other. In one or more embodiments, the AR display device 100 includes different types of head-mounted devices such as AR/MR glasses, AR/MR headbands, or AR/MR helmets. The difference between Mixed Reality (MR) and Augmented Reality (AR) is that the MR technology more highlights the virtual information, while the AR technology more highlights the real information. There is no essential difference between the above two technical solutions. Therefore, in the present invention, AR collectively refers to a technology that includes augmented reality such as AR and MR. The mobile terminal 200 is a mobile terminal device such as a smart phone, a tablet computer, or a notebook computer, which has a human-computer interaction interface, a computing capability, a storage capability, and a communication capability. The mobile terminal 200 and the AR display device 100 are connected in a wired or wireless manner such as a network cable, a USB data cable, WIFI, and Bluetooth. In some alternative embodiments, the mobile terminal 200 may be replaced by a non-mobile terminal. For example, a desktop computer located in a control center may be used to send a control signal to the AR display device 100.

In one or more embodiments, the mobile terminal 200 is configured to send a control instruction to the AR display device 100, so that the AR display device 100 displays AR content corresponding to the control instruction. The control instruction includes an experience mode instruction and a promotion mode instruction. In particular, the control instruction of the mobile terminal 200 may be transmitted through a UI interface on the mobile terminal 200, which may be selected by an operator of the mobile terminal 200. As shown in FIG. 2, a schematic diagram of a UI interface of the mobile terminal is shown. In one of the embodiments, there are two interactive buttons on the interface of the mobile terminal 200, namely an experience mode and a promotion mode. When the operator selects the experience mode, the mobile terminal 200 sends an experience mode instruction to the AR display device 100; when the operator selects the promotion mode, the mobile terminal 200 sends a promotion mode instruction to the AR display device 100. Preview renderings of different modes may be displayed in the circle in the upper right corner of FIG. 2 for the operator to preview.

In one or more embodiment, the AR display device 100 detects, after receiving the control instruction, whether a user's Field of View (FOV) is in a preset initial position. If the user's FOV is in the preset initial position, playing of the AR content is started, a change in a user's position and orientation is sensed through an IMU sensor, and the AR content is adjusted. In particular, since the AR display device 100 is a near-eye display, the FOV direction of the user also corresponds to the FOV direction of a display screen of the AR display device 100. Therefore, in the process of combining virtual and real scenes, it is necessary to ensure that the user's FOV is in an appropriate position to avoid mismatch between the virtual information and the real scene after the combination of the virtual and real scenes. For example, in a sales navigation scene of manned equipment with an automobile as an example, the AR content that needs to be presented to the user through the AR display device 100 is description of function keys inside the automobile and the actual effect demonstration. Therefore, the initial position is set as the user's FOV facing the center of the automobile steering wheel. After determining that the user's FOV is in the initial position, the AR content is started, so that the AR content matches the layout of the real automobile function keys. The IMU sensor provided on the AR display device 100 detects a change in a user's position and orientation (for example, including head turning, head down, head up, etc.), to accordingly operate the AR content being played currently, so that the display of the AR content matches the real scene.

After the AR display device 100 receives the experience mode instruction, the mobile terminal 200 does not subsequently intervene in the interaction process between the AR display device 100 and the user. That is, after entering the experience mode, the content displayed by the AR display device 100 is not related to the operation of the mobile terminal 200, unless the AR display device 100 exits the experience mode through an instruction from the mobile terminal 200. In one of the embodiments, the AR content in the experience mode includes a combination of one or more media forms such as 3D model, video, text, or audio. In a specific example, in a sales navigation scene of manned equipment with an automobile as an example, a salesperson may let a customer wear the AR display device 100, and then the salesperson sends an experience mode instruction through the mobile terminal 200, so that the AR display device 100 worn by the user enters the experience mode. In the experience mode, according to the pre-set content, the user may see an advertising video and a test drive experience video of the automobile products that the user pays attention to, so that it is convenient for the user to make further decisions about whether to make subsequent purchases.

In other embodiments, the AR display device 100 detects the user's location through the positioning technique, and plays the AR content corresponding to the specific location according to the user's specific location. In one of the embodiments, when the AR navigation system is applied to the sales navigation of manned equipment with an automobile as an example, the AR display device 100 detects, by using a positioning technique, whether the user is in a main driver seat, a co-driver seat, or a rear seat, and plays AR content corresponding to the main driver seat, the co-driver seat, or the rear seat according to the user's location. For example, when the user is in the main driver seat, the AR content is AR content that matches the main driver seat, such as AR content of the main driver seat view video, or an operation introduction of the main driver seat; when the user is in the rear seat, the AR content is AR content that matches the rear seat of the automobile, such as an operation guide for the rear of the automobile, a driving experience video of the rear, and an introduction of the safety performance of the rear. In one or more embodiments, the positioning technique that may be used includes one or more of CV positioning, WIFI positioning, Bluetooth positioning, NFC positioning, and RFID positioning. The CV positioning is to identify the feature of the scene in the user's Field of View (FOV) direction through the CV algorithm by the camera located on the AR display device, thereby determining the current location of the user. The WIFI positioning, the Bluetooth positioning, the NFC positioning, the RFID positioning are all indoor positioning methods. The current position may be determined by one or more transmitting points set indoors by using the strength of the signal received by the receiving point on the AR display device 100.

In one or more embodiments, the AR display device 100 is also communicatively connected with the manned device and receives an operation instruction on the manned device from the user, and the AR display device 100 adjusts the AR content according to the operation instruction. In one of the embodiments, taking an automobile as an example, the AR display device may be communicatively connected with the automobile through Bluetooth, WIFI, USB data cable, etc. At this time, the automobile may receive a user's operation, convert the user's operation into an operation instruction which is sent to the AR display device 100, thereby controlling the presentation mode of AR content. In one example, if the AR content is simulated driving content, the AR display device 100 may control the steering of the automobile in simulated driving according to the operation of the user turning the steering wheel. In another example, if the AR content is an automobile function display, the corresponding function introduction may be played in the AR content according to the user's operations such as pressing and rotating on the function keys. As a result, the user may complete the use experience of the vehicle through the AR display device without a real test drive, so as to improve the efficiency of automobile sales.

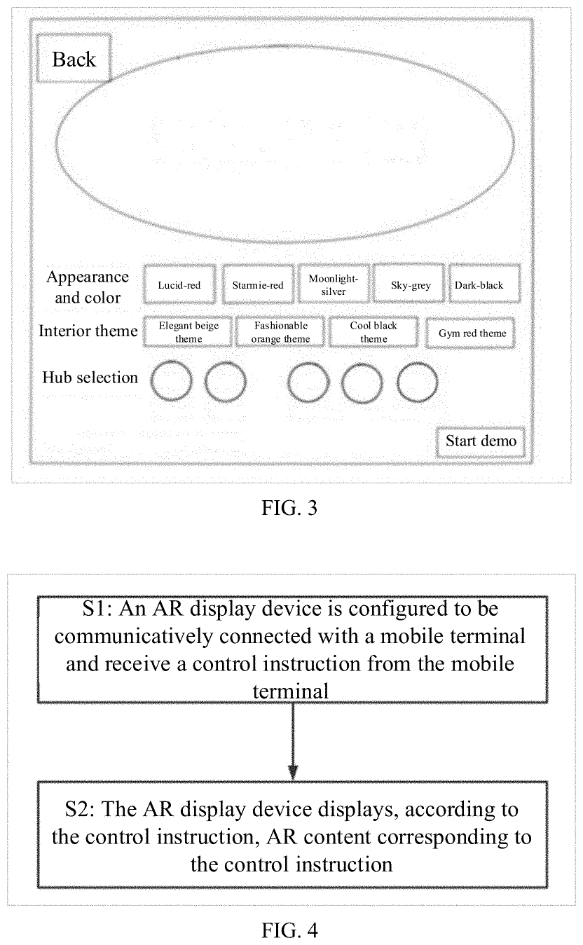

After the AR display device 100 receives a promotion mode instruction, the promotion mode instruction causes the AR display device 100 to enter the promotion mode, and the mobile terminal 200 enters a promotion menu page; according to a combination of activation items of the promotion menu page, the mobile terminal 200 sends a display instruction to the AR display device 100, so that the AR display device 100 displays AR content corresponding to the combination of the activation items. In particular, as shown in FIG. 3, a schematic diagram of a UI interface of a mobile terminal of an AR navigation system according to one or more embodiments of the present invention is shown. The scene in FIG. 3 is a sales navigation of manned equipment with an automobile as an example. In FIG. 3, the operator of the mobile terminal 200 (that is, the automobile salesman) may select the options in the appearance color, interior theme and hub selection menus of the automobile, and make one of these menus active. After the selection, the activation items of these menus may be combined by clicking a “start demo” button, to form a display instruction, which is sent to the AR display device 100, so that the AR display device 100 displays a corresponding automobile model, and the consumer may see the AR content of the corresponding automobile model.

In some of these embodiments, the AR content may be stored in the mobile terminal 200 or cloud server, and transmitted to the AR display device 100 along with the control instruction or display instruction through a communication connection. However, in this case, the pre-configuration work for the AR display device may be reduced. However, since the data volume of AR content will be relatively large, the display of AR content may be restricted when the communication speed is limited. In other embodiments, the AR content may be stored locally in the AR display device 100 and adjusted through the control instruction or display instruction of the mobile terminal. In this case, it is necessary to store the AR content in the AR display device in advance, but the display of the AR content is not restricted by the communication connection.

As shown in FIG. 4, according to another aspect of the present invention, a flowchart of an AR navigation method according to one or more embodiments of the present invention is shown, including the following steps:

S1: An AR display device is configured to be communicatively connected with a mobile terminal and receive a control instruction from the mobile terminal.

S2: The AR display device displays, according to the control instruction, AR content corresponding to the control instruction.

In step S1, the control instruction includes an experience mode instruction and a promotion mode instruction. In particular, the control instruction of the mobile terminal may be transmitted through a UI interface, which may be performed by an operator of the mobile terminal. As shown in FIG. 2, a diagram of a UI interface of a mobile terminal is shown. There are two interactive buttons on the interface of the mobile terminal, namely an experience mode and a promotion mode. When the operator selects the experience mode, the mobile terminal sends an experience mode instruction to the AR display device; when the operator selects the promotion mode, the mobile terminal sends a promotion mode instruction to the AR display device. Preview renderings of different modes may be displayed in the circle in the upper right corner of FIG. 2 for the operator to observe.

In step S2, the AR display device detects, after receiving the control instruction, whether the user's Field of View (FOV) is in a preset initial position. If the user's FOV is in the preset initial position, playing of the AR content is started, a change in a user's position and orientation is sensed through an IMU sensor, and the AR content is adjusted. In particular, since the AR display device is a near-eye display, the FOV direction of the user also corresponds to the FOV direction of the display screen of the AR display device. Therefore, in the process of combining virtual and real scenes, it is necessary to ensure that the user's FOV is in an appropriate position to avoid mismatch between the virtual information and the real scene after the combination of the virtual and real scenes. For example, in a sales navigation scene of manned equipment with an automobile as an example, the AR content that needs to be presented to the user through the AR display device is case description and actual effect demonstration inside the automobile. Therefore, the initial position is set as the user's FOV facing the center of the automobile steering wheel. After determining that the user's FOV is in the initial position, the AR content is started, so that the AR content matches the real automobile operating interface. The IMU sensor provided on the AR display device detects a change in a user's position and orientation (for example, including head turning, head down, head up, etc.), to accordingly operate the AR content being played currently, so that the display of the AR content matches the real scene.

Further implementations in steps Si and S2 are consistent with or similar to one or more embodiments described above with respect to the AR navigation system, and achieve the same or similar technical effects, and will not be repeated herein.

The above are only preferred embodiments of the present invention, and do not limit the present invention in any form. Although the present invention has been disclosed as above in preferred embodiments, it is not intended to limit the present invention. Any skilled person familiar with the art may make some changes or modifications to equivalent embodiments by using the above disclosed technical contents without departing from the technical solution of the present invention. However, any simple modifications, equivalent changes and modifications made to the above embodiments based on the technical essence of the present invention still fall within the scope of the technical solution of the present invention, without departing from the content of the technical solution of the present invention.

What is claimed is:

1. An AR navigation system, comprising:
an AR display device configured to provide a near-eye display function; and
a mobile terminal communicatively connected with the AR display device, wherein
the mobile terminal is configured to send a control instruction to the AR display device, so that the AR display device displays AR content corresponding to the control instruction.

2. The AR navigation system according to claim 1, wherein that the mobile terminal is configured to send the control instruction to the AR display device, so that the AR display device displays the AR content corresponding to the control instruction further comprises:
detecting, by the AR display device after receiving the control instruction, whether a user's FOV is in a preset initial position; and
displaying the AR content if the user's FOV is in the preset initial position; and
adjusting the AR content in response to sensing a change in a user's position and orientation through an IMU sensor.

3. The AR navigation system according to claim 1, wherein the control instruction comprises: an experience mode instruction,
wherein the experience mode instruction causes the AR display device to enter an experience mode and play the AR content preset in the AR display device.

4. The AR navigation system according to claim 1, wherein the control instruction comprises a promotion mode instruction,
the promotion mode instruction causes the AR display device to enter a promotion mode, and the mobile terminal enters a promotion menu page; and
according to a combination of activation items of the promotion menu page, the mobile terminal sends a display instruction to the AR display device, so that the AR display device displays AR content corresponding to the combination of the activation items.

5. The AR navigation system according to claim 3, wherein
in the experience mode, the AR display device detects a specific location of the user through a positioning technique and plays AR content corresponding to the specific location according to the specific location of the user.

6. The AR navigation system according to claim 5, when applied to a sales navigation of a manned device, operations of the AR navigation system further comprising:
detecting, by the AR display device, whether the user is in a main driver seat, a co-driver seat, or another seat through the positioning technique, and playing AR content corresponding to the main driver seat, the co-driver seat or the another seat according to the user's location,
the positioning technique comprising one or more of CV positioning, WIFI positioning, Bluetooth positioning, NFC positioning, and RFID positioning.

7. The AR navigation system according to claim 6, wherein
the AR display device is further communicatively connected with the manned device and receives an operation instruction on the manned device from the user, and
the AR display device adjusts the AR content according to the operation instruction.

8. An AR navigation method, comprising:
an AR display device being configured to be communicatively connected with a mobile terminal and receive a control instruction from the mobile terminal; and
displaying, by the AR display device according to the control instruction, AR content corresponding to the control instruction.

9. The method according to claim 8, wherein the displaying, by the AR display device according to the control instruction, AR content corresponding to the control instruction further comprises:
detecting, by the AR display device after receiving the control instruction, whether a user's FOV is in a preset initial position; and
displaying the AR content if the user's FOV is in the preset initial position; and
adjusting the AR content in response to sensing a change in a user's position and orientation through an IMU sensor.

10. The method according to claim 8, wherein the control instruction comprises:
an experience mode instruction,
wherein the experience mode instruction causes the AR display device to enter an experience mode and play the AR content preset in the AR display device.

11. The method according to claim 10, wherein the control instruction comprises a promotion mode instruction,
the promotion mode instruction causes the AR display device to enter a promotion mode, and the mobile terminal enters a promotion menu page; and
according to a combination of activation items of the promotion menu page, the mobile terminal sends a display instruction to the AR display device, so that the AR display device displays AR content corresponding to the combination of the activation items.
